(19) United States
(12) Patent Application Publication
(10) Pub. No.: US 2019/0079333 A1
(43) Pub. Date: Mar. 14, 2019

(54) ELECTRONIC DISPLAY WITH AN IMPROVED DEAD-FRONT PRESENTATION

(71) Applicant: VISTEON GLOBAL TECHNOLOGIES, INC., Van Buren Township, MI (US)

(72) Inventors: Qais Sharif, Northville, MI (US); Paul Fredrick Luther Weindorf, Novi, MI (US)

(21) Appl. No.: 15/700,994

(22) Filed: Sep. 11, 2017

(51) Int. Cl. G02F 1/137; G02F 1/1335; G02F 1/1337; G02F 1/133

(52) U.S. Cl. CPC G02F 1/13725; G02F 1/133526; G02F 1/133784; G09G 3/3406; G02F 2203/64; G02F 2202/04; G02F 1/13318

(57) ABSTRACT

Disclosed herein is an electronic display with an improved dead-front presentation. The electronic display includes a backlit display configured to present content; and a dichroic guest host dye layer disposed on the backlit display. The display may incorporate a lens (in various positions), as well as a strategically disposed air gap. Certain implementations may employ curved lens technology.

### BACKGROUND

Electronic displays are provided in many contexts to electronically render digital information to a viewer. The electronic displays receive information, and renders the information through lighted cells in patterns that reflect the texts and pictures employed to convey the information.

The electronic displays may be implemented in a variety of environments where electronic displays have not traditionally been employed, such as a vehicle, home appliance, advertisement/billboard, and the like. Accordingly, for aesthetic purposes, when employing said electronic displays, ensuring that said electronic displays blend into a bezel or background may be desired.

This effect, also known as a “dead-front”, and has been attempted by numerous implementers of electronic displays integrated into a variety of contexts and environments. Several implementations have been attempted; however, with each implementation drawbacks become apparent.

### SUMMARY

The following description relates to providing a system, method, and device an electronic display with an improved dead-front presentation. Exemplary embodiments may also be directed to any of the system, the method, or an application disclosed herein, and the subsequent implementation in a vehicular context.

Disclosed herein is an electronic display. The electronic display includes a backlit display configured to present content; and a dichroic guest host dye layer disposed on the backlit display.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIGS. 1(a) and (b) illustrate an example of the operating principles associated with a dichroic guest host dye layer;

FIG. 2 illustrates a side-view of an implementation of a display implementing the aspects disclosed herein;

FIG. 3 illustrates a side-view of a second implementation of a display implementing the aspects disclosed herein;

FIG. 4 illustrates a side-view of a third implementation of a display implementing the aspects disclosed herein;

FIG. 5 illustrates a side-view of a fourth implementation of a display implementing the aspects disclosed herein;

FIG. 6 illustrates a side-view of a fifth implementation of a display implementing the aspects disclosed herein;

FIG. 7 illustrates a side-view of a sixth implementation of a display implementing the aspects disclosed herein;

FIG. 8 illustrates a side-view of a seventh implementation of a display implementing the aspects disclosed herein;

FIG. 9 illustrates a side-view of an eight implementation of a display implementing the aspects disclosed herein;

FIG. 10 illustrates a side-view of a ninth implementation of a display implementing the aspects disclosed herein;

FIG. 11 illustrates a side-view of a tenth implementation of a display implementing the aspects disclosed herein;

FIG. 12 illustrates a side-view of an eleventh implementation of a display implementing the aspects disclosed herein; and

FIG. 13 illustrates a side-view of a twelfth implementation of a display implementing the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

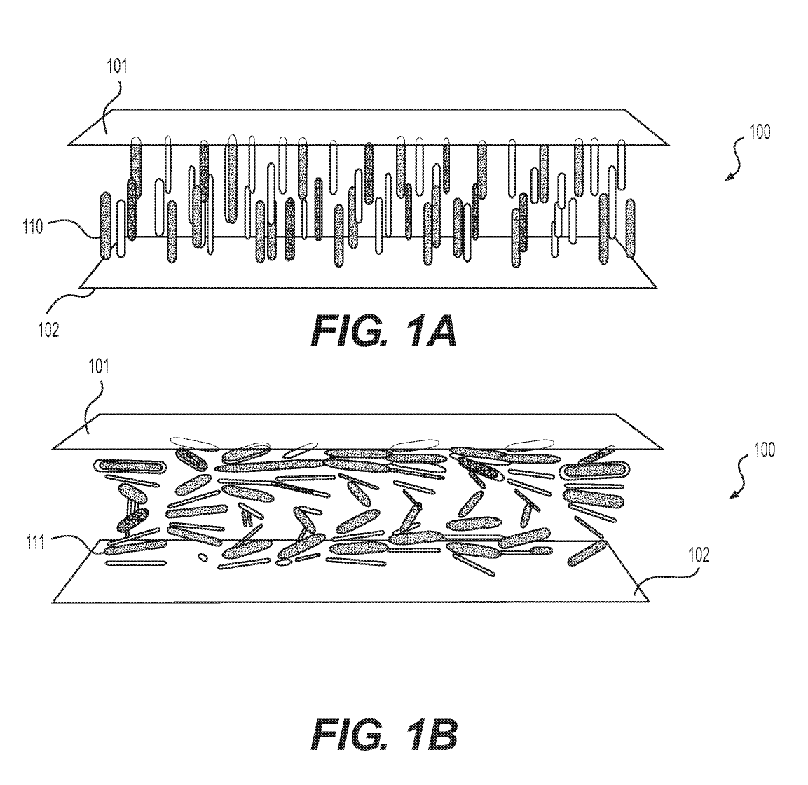

The aspects disclosed herein employ dichroic guest host dye technology. FIGS. 1(a) and (b) illustrate an example of the operating principles associated with a dichroic guest host dye layer 100. Referring to both FIGS. 1(a) and (b), an exemplary cell is shown, with an electrode 101 and 102. In the context of this description, the term “dichroic guest host dye layer 100” includes the outer substrates, electrode layers and rubbing layers commonly used to construct and liquid crystal cell in addition to the guest host liquid crystal material. The substrates may be plastic, glass or other suitable materials. The transparent electrodes may be indium tin oxide (ITO) or other suitable materials. The rubbing layers used to anchor the liquid crystal material may be polyimide or other suitable materials.

Referring to FIG. 1(a), an ‘on’ state is shown. As such, light is allowed to pass through. In FIG. 1(a), a collection of dichroic dye crystals 110 are shown, and are orthogonal to each of electrodes 101 and 102.

Referring to FIG. 1(b), an ‘off state is shown. As such, light is effectively blocked, or the transmission of light is reduced. Thus, the same dichroic crystals are now in non-orthogonal state 111. During the non-orthogonal state 111, light is not allowed to reflect through (or the transmission of light is limited). As such, a “dead-front” appearance is achieved. Intermediate levels of transmission are also possible between the fully “off” and fully “on” states.

In the employment of a dichroic guest host dye layer 100, the amount of transmission allowed in each state may be set by the concentration dichroic guest host dye employed in the construction of the layer 100. As such, an implementer employing the layer in the manners described herein may adjust the concentration accordingly.

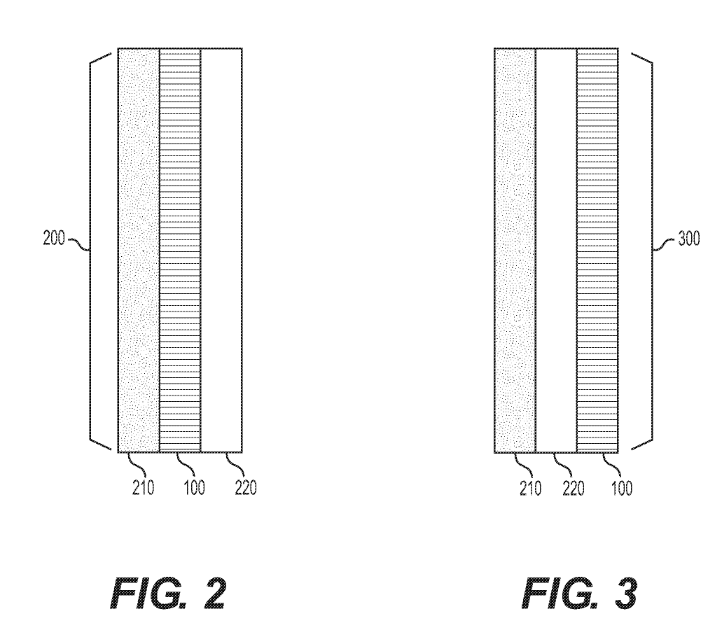

FIG. 2 illustrates a side-view of an implementation of a display 200 implementing the aspects disclosed herein. A backlit display 210 is shown first, at a left most position. This layer is physically furthest away from the viewer.

Disposed on the backlit layer 210 is a dichroic guest host dye layer 100. This layer is electrically coupled to a control signal (not shown), and in response to the display 210 displaying information, is effectively controlled to be in an ‘on state’ 110, and in response to the display 210 being off, is effectively controlled to be in an ‘off state’ 111. Intermediate transmission states are also possible and the dichroic guest host dye layer 100 may be adjusted or driven in accordance with the ambient lighting conditions using light sensor(s) in order to maintain display visibility while keeping the lowest useable transmission level to keep a dead front appearance.

Disposed on the dichroic guest host dye layer 100 is a glass or plastic lens 220. This lens 220 is see-through, and allows light to be transmitted from the display 210, the dichroic guest host dye layer 100 (when in the ‘on state’ 110) to a viewer.

In display 200, when the layers are shown in abutment with each other, this implies the layers are physically touching each other as shown, and physically in abutment with each other, utilizing optical bonding or other suitable means.

FIG. 3 illustrates a side-view of an implementation of a display 300 implementing the aspects disclosed herein. Display 300 is similar to display 200, however the lens 220 and the dichroic guest host dye layer 100 are switched

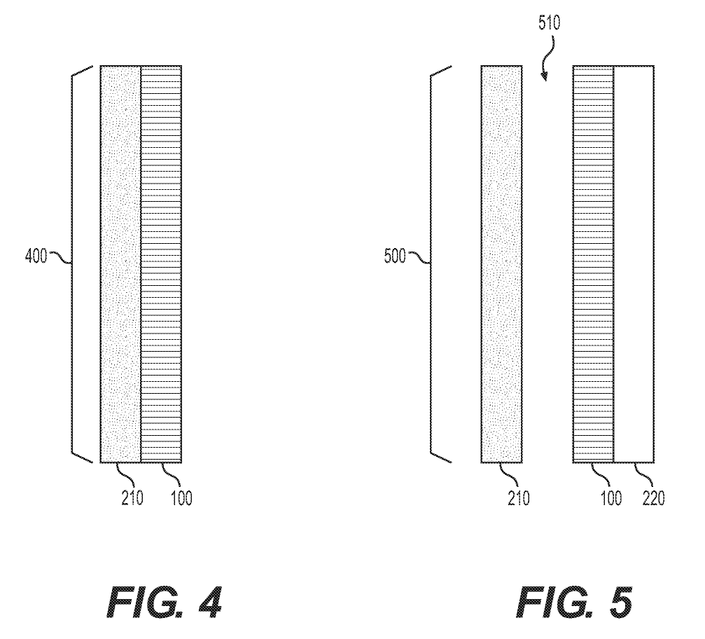

FIG. 4 illustrates a side-view of an implementation of a display 400 implementing the aspects disclosed herein. Display 400 is similar to display 200, except a lens 220 is not implemented.

FIG. 5 illustrates a side-view of an implementation of a display 500 implementing the aspects disclosed herein. Display 500 is similar to display 200; however, an air gap 510 is added in between the display 210 and the dichroic guest host dye layer 100.

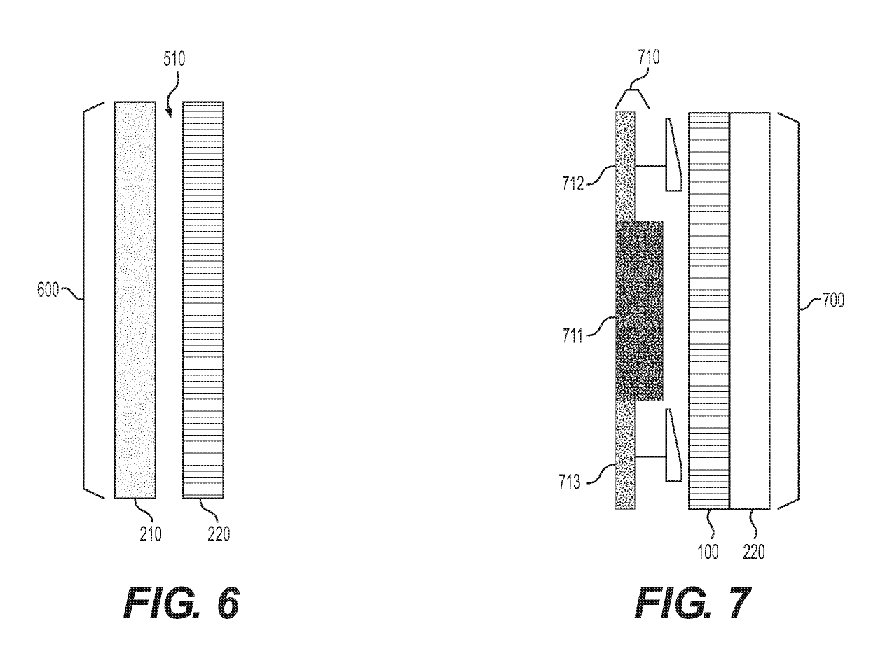

FIG. 6 illustrates a side-view of an implementation of a display 600 implementing the aspects disclosed herein. Display 600 is similar to display 500; however, a lens 220 is not included.

FIGS. 7-9 illustrate various side-views of a different sort of display 710 incorporating the aspects disclosed herein. The display 710 shown in these views incorporates at least one mechanical gauge and a backlit display.

Referring to FIG. 7, the display 710 includes mechanical gauges 712 and 713, with a backlit display 711 disposed between. Thus, all three elements 711-713 are visible to a viewer of the display 710. In FIG. 7, the display 700 shown includes a dichroic guest host dye layer 100 disposed to overlap with the display 710 (but not in physical abutment), and a lens 220.

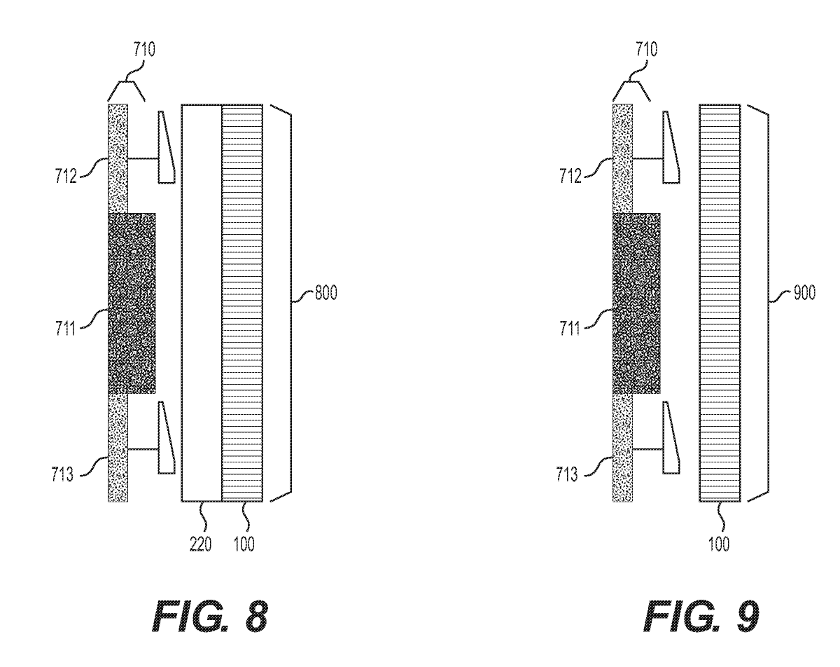

Referring to FIG. 8, the display 800 is similar to the display 700, however, the placement the dichroic guest host dye layer 100 and the lens 220 are switched. Referring to FIG. 9, display 900 is similar to display 700, however the lens 220 is omitted.

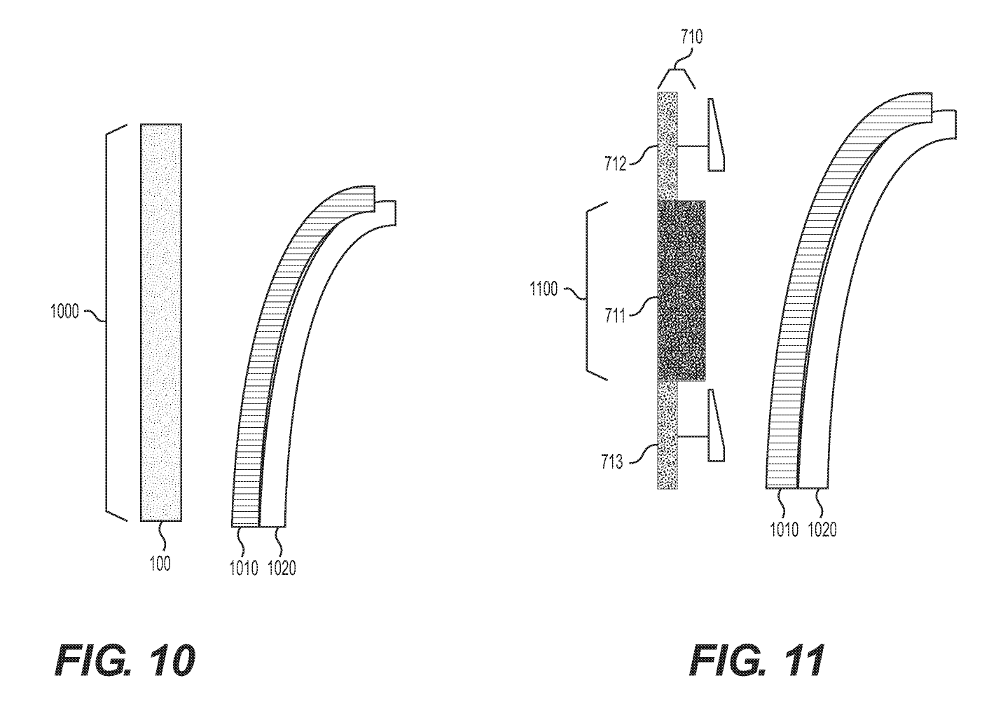

FIGS. 10-13 illustrate side-views of displays employing curved structures. In these implementations, the dichroic guest host dye layer 100 is replaced with a curved dichroic guest host dye layer 1010. Similarly and where shown, the lens 220 is replaced with a curved lens 1020.

Referring to FIG. 10, display 1000 is shown with a curved dichroic guest host dye layer 1010 and a curved lens 1020. Although not shown, in another embodiment the curved lens 1020 may be omitted based on an implementer's choice.

Referring to FIGS. 11-13, display 710 is implemented in lieu of display 100. In FIG. 11, display 1100 is similar to display 1000 except for the above-mentioned difference.

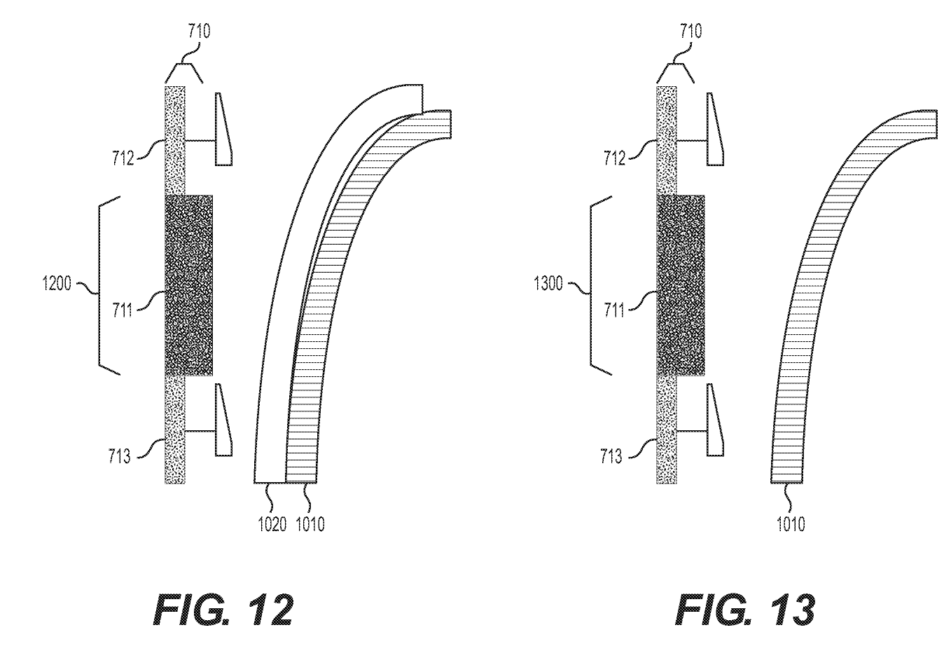

In FIG. 12, display 1200 is similar to display 1100, however, the curved dichroic guest host dye layer 1010 and the curved lens 1020 are switched. Finally, in FIG. 13, display 1300 is similar to displays 1100 and 1200, except the curved lens 1020 is omitted

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An electronic display, comprising:
a backlit display configured to present content; and
a dichroic guest host dye layer disposed on the backlit display.

2. The display according to claim 1, further comprising a circuit electrically coupled to the backlit display and the dichroic guest host dye layer, wherein in response to the backlit display being on, the dichroic guest host dye layer is configured to orient guest host dye crystals included therein in an orthogonal orientation to the backlit display, and in response to the backlit display being off, the dichroic guest host dye layer is configured to orient guest host dye crystals included therein in a parallel orientation to the backlit display.

3. The display according to claim 2, further comprising a transparent lens.

4. The display according to claim 3, wherein the dichroic guest host dye layer is in physical abutment with the backlit display, and the transparent lens is in physical abutment with the dichroic guest host dye layer.

5. The display according to claim 3, wherein the dichroic guest host dye layer is in physical abutment with the transparent lens, and the transparent lens is in physical abutment with the backlit layer.

6. The display according to claim 2, further comprising an air gap in between the backlit display and the dichroic guest host dye layer.

7. The display according to claim 3, further comprising an air gap in between the backlit display and the dichroic guest host dye layer.

8. The display according to claim 1, further comprising at least one mechanical gauge included with the backlit display.

9. The display according to claim 3, further comprising at least one mechanical gauge included with the backlit display.

10. An electronic display, comprising:
a backlit display configured to present content; and
a curved dichroic guest host dye layer disposed on the backlit display.

11. The display according to claim 10, further comprising a circuit electrically coupled to the backlit display and the curved dichroic guest host dye layer, wherein in response to the backlit display being on, the curved dichroic guest host dye layer is configured to orient guest host dye crystals included therein in an orthogonal orientation to the backlit display, and in response to the backlit display being off, the curved dichroic guest host dye layer is configured to orient guest host dye crystals included therein in a parallel orientation to the backlit display.

12. The display according to claim 11, further comprising a curved transparent lens.

13. The display according to claim 11, further comprising at least one mechanical gauge included with the backlit display.

14. The display according to claim 12, further comprising at least one mechanical gauge included with the backlit display.

15. The display according to claim 1, further comprising a sensor, the sensor being coupled to the dichroic guest host dye layer, wherein the dichroic guest host dye layer is configured to maintain an intermediate transmission state based on sensed data from the sensor.

16. The display according to claim 10, further comprising a sensor, the sensor being coupled to the dichroic guest host dye layer, wherein the dichroic guest host dye layer is configured to maintain an intermediate transmission state based on sensed data from the sensor.
